(19) United States
(12) Patent Application Publication
(10) Pub. No.: US 2026/0308443 A1
(43) Pub. Date: Oct. 8, 2026

(54) COMPOSITIONS AND METHODS OF BIOCIDE POTENTIATION

(71) Applicant: Solugen, Inc., Houston, TX (US)

(72) Inventors: Matheus Paes Paschoalino, Orlando, FL (US); Darlen Galicia, Houston, TX (US); Ty Hanna, Houston, TX (US); Shauheen Noorani, Houston, TX (US); Gaurab Chakrabarti, Houston, TX (US); Sean Hunt, Houston, TX (US)

(73) Assignee: Solugen, Inc., Houston, TX (US)

(21) Appl. No.: 19/638,859

(22) Filed: Apr. 3, 2026

Related U.S. Application Data
(60) Provisional application No. 63/783,160, filed on Apr. 3, 2025.

(51) Int. Cl. C09K 8/60; A01N 31/02

(52) U.S. Cl. CPC C09K 8/605; A01N 31/02

(57) ABSTRACT

A composition including a biocide and a biocide potentiator. The biocide potentiator includes a sugar oxidation product. A method of servicing a system including an aqueous fluid includes introducing to the system an aqueous composition. The aqueous composition includes a biocide and a biocide potentiator. The biocide potentiator includes a sugar oxidation product.

### CROSS-REFERENCE TO RELATED APPLICATIONS

This application claims priority to U.S. Provisional Application No. 63/783,160 filed Apr. 3, 2025, and entitled “Compositions and Methods of Biocide Potentiation,” which is hereby incorporated herein by reference in its entirety for all purposes.

### STATEMENT REGARDING FEDERALLY SPONSORED RESEARCH OR DEVELOPMENT

Not applicable.

### TECHNICAL FIELD

The present disclosure relates generally to biocides. More particularly, the present disclosure relates to potentiating biocidal activity. Still more particularly, the present disclosure relates to biocidal compositions with improved stability.

### BACKGROUND

Biocide refers to compositions that are intended to destroy, deter, render harmless, prevent the action of, or otherwise exert a controlling effect on one or more pathogens by chemical or biological means. Biocides are chemical or biological agents designed to kill, deter, or control harmful organisms such as bacteria, fungi, algae, and viruses. Unlike antibiotics, which are used to treat infections in living tissue, biocides are primarily applied to inanimate objects, surfaces, and industrial systems to prevent contamination, spoilage, and structural damage. In industrial settings, biocides serve roles such as (i) asset protection as they prevent microbially influenced corrosion and (ii) maintain system efficiency primarily by reducing biofouling. For example, biocides in wellbore servicing operations can be used in drilling mud to maintain fluid integrity and in hydraulic fracturing to prevent reservoir “souring” caused by sulfate-reducing bacteria. In water treatment, biocides are utilized for maintaining microbiological quality in drinking water and preventing the growth of pathogens like Legionella in industrial cooling systems. An ongoing challenge with the use of biocides is the ability to maintain effective levels of these materials over time. Thus, an ongoing need exists for biocides that can address these challenges.

### BRIEF SUMMARY OF THE DISCLOSURE

Disclosed herein are compositions comprising (i) a biocide and (ii) a biocide potentiator comprising a sugar oxidation product.

Also disclosed herein is a method of servicing a system comprising an aqueous fluid, the method comprising introducing to the system an aqueous composition comprising (i) a biocide and (ii) a biocide potentiator comprising a sugar oxidation product.

Aspects described herein comprise a combination of features and characteristics intended to address various shortcomings associated with certain prior devices, systems, and methods. The foregoing has outlined rather broadly the features and technical characteristics of the disclosed aspects in order that the detailed description that follows may be better understood. The various characteristics and features described above, as well as others, will be readily apparent to those skilled in the art upon reading the following detailed description, and by referring to the accompanying drawings. It should be appreciated that the conception and the specific aspects disclosed may be readily utilized as a basis for modifying or designing other structures for carrying out the same purposes as the disclosed aspects. It should also be realized that such equivalent constructions do not depart from the spirit and scope of the principles disclosed herein.

### BRIEF DESCRIPTION OF THE DRAWINGS

For a detailed description of various exemplary aspects, reference will now be made to the accompanying drawings in which:

FIG. 1A depicts exemplary 96 well microtiter plates; and

FIG. 1B depicts another set of exemplary 96 well microtiter plates.

### DETAILED DESCRIPTION

The following discussion is directed to various exemplary aspects. However, one skilled in the art will understand that the examples disclosed herein have broad application, and that the discussion of any aspect is meant only to be exemplary of that aspect, and not intended to suggest that the scope of the disclosure, including the claims, is limited to that aspect.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in interest of clarity and conciseness.

Unless the context dictates the contrary, all ranges set forth herein should be interpreted as being inclusive of their endpoints, and open-ended ranges should be interpreted to include only commercially practical values. In addition, with respect to all ranges disclosed herein, such ranges are intended to include any combination of the mentioned upper and lower limits even if the particular combination is not specifically listed. All lists of values should be considered as inclusive of intermediate values unless the context indicates the contrary. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc. ; greater than 0.10 includes 0.11, 0.12, 0.13, etc.).

In the following discussion and in the claims, the terms “including” and “comprising” are used in an open-ended fashion, and thus should be interpreted to mean “including, but not limited to . . . .” As used herein, the phrases “consist(s) of” and “consisting of” are used to refer to exclusive components of a composition, meaning only those expressly recited components are included in the composition; whereas the phrases “consist(s) essentially of” and “consisting essentially of” are used to refer to the primary components of a composition, meaning that only small or trace amounts of components other than the expressly recited components (e.g. 'impurities'byproducts' etc.) may be included in the composition. For example, a composition consisting of X and Y refers to a composition that only includes X and Y, and thus ' does not include any other components and a composition consisting essentially of X and Y refers to a composition that primarily comprises X and Y, but may include small or trace amounts of components other than X and Y. In aspects described herein; any such small or trace amounts of components other than those expressly recited following the phrase “consist(s) essentially of” or “consisting essentially of” preferably represent less than 5.0 wt. % of the composition, more preferably less than 4.0 wt. % of the composition even more preferably less than 3.0 wt. % of the composition and still more preferably less than 1.0 wt. % of the composition. Use of broader terms such as comprises, includes, having, etc. should be understood to provide support for narrower terms such as consisting of, consisting essentially of, comprised substantially of, etc. Use of the term “optionally” with respect to any element of a claim is intended to mean that the subject element is required, or alternatively, is not required. Both alternatives are intended to be within the scope of the claim. As used herein, the terms “approximately,” “about,” “substantially,” and the like mean within 10% (i.e., plus or minus 10%) of the recited value. Thus, for example, a recited angle of “about 80 degrees” refers to an angle ranging from 72 degrees to 88 degrees.

Disclosed herein are compositions comprising (i) a biocide and (ii) a biocide potentiator which are referred to herein as stabilized biocide compositions and designated SBC. In an aspect, the biocide of the SBC comprises a precursor compound which is characterized by having low to no biocidal activity but after being introduced to a system (e.g., soil, aqueous fluid) reacts to form one or more products that exert a controlling effect on microorganisms within the system. Biocidal activity may be determined by using any suitable methodology. For example, the minimum inhibitory concentration (MIC) can be determined. The MIC is lowest concentration of a biocide that successfully inhibits the visible growth of a test organism. Determination of the MIC may be carried out by exposing microorganisms exposed to varying concentrations of the biocide in nutrient broth or agar. The smallest amount that prevents growth is recorded as the MIC.

In one or more aspects, a biocide for use in the SBC comprises a precursor compound which reacts to form at least one product wherein the at least one product has biocidal activity that is greater than that of the precursor compound. In some aspects, a biocide for use in the SBC reacts to release formaldehyde.

Nonlimiting examples of biocides suitable for use in the present disclosure include, 1,3-bis(hydroxymethyl)-5,5-dimethylimidazolidine-2,4-dione (DMDM hydantoin), 3,5-dimethyl-1,3,5-thiadiazinane-2-thione (DAZOMET), tris(hydroxymethyl)nitromethane (THNM), cetyltrimethylammonium chloride (CTAC), 3,3′-methylenebis[5-methyloxazolidine (MBO), 2,6-dimethyl-m-dioxane-4-ol acetate (DMO), (ethylenedioxy)dimethanol (EDDM), tetramethylolacetylene diurea (TMAD), benzylhemiformal, 2-bromo-2-nitropropane-1,3-diol, 5-bromo-5-nitro-1,3-dioxane, diazolidinyl urea, imidazolidinyl urea, sodium hydroxymethylglycinate and hexamethylenetetramine chloroallyl chloride (QUATERNIUM-15).

A biocide potentiator suitable for use in the SBC comprises a sugar oxidation product. In one or more aspects, the biocide potentiator comprises aldonic acid, uronic acid, aldaric acid or a combination thereof and a counter cation.

Additionally or alternatively, the one or more sugar oxidation products comprise a glucose oxidation product, a gluconic acid oxidation product, a gluconate, or combinations thereof. The glucose oxidation product, gluconic acid oxidation product, or combination thereof may be buffered to a suitable pH.

Additionally or alternatively, the one or more sugar oxidation products comprise glucaric acid, gluconic acid, glucuronic acid, glucose oxidation products, gluconic acid oxidation products, or combinations thereof. Additionally or alternatively, the one or more sugar oxidation products comprise disaccharides, oxidized disaccharides, uronic acid, aldaric acid or a combination thereof.

Additionally or alternatively, the one or more sugar oxidation products comprise gluconic acid, glucaric acid, glucuronic acid, n-keto-acids, C₂ to C₆ diacids, or combinations thereof.

Additionally or alternatively, the one or more sugar oxidation products comprise galactonic acid, galactaric acid, an oxidation product comprising predominantly (e.g., greater than about 50 weight percent) galactonic acid and/or galactaric acid with minor component species of n-keto-acids, C₂ to C₆ diacids, or combination thereof. Additionally or alternatively, the one or more sugar oxidation products comprise glutamic acid. Additionally or alternatively, the one or more sugar oxidation products comprise glucodialdose, 2-ketoglucose, or combinations thereof.

In such aspects, the buffered glucose oxidation product, the buffered gluconic acid oxidation product, or combinations thereof are buffered to a suitable pH. For example, the glucose oxidation product, gluconic acid oxidation product, or combination thereof may be buffered to a pH in the range of from about 1 to about 5. In various aspects, buffering of the one or more sugar oxidation products may be carried using any suitable acid, base, or combination thereof.

In one or more aspects, the one or more sugar oxidation products comprise aldonic acid, uronic acid, aldaric acid, a gluconic acid oxidation product, a gluconate, glucaric acid, gluconic acid, glucuronic acid, glucose oxidation products, galactonic acid, galactaric acid, glutamic acid, a lactone of gluconic acid, a lactone of glucaric acid, a lactone of galactaric acid, a lactone of galactonic acid, glucodialdose, 2-ketoglucose, disaccharides, oxidized disaccharides, n-keto-acids, C₂ to C₆ diacids, salts thereof, or combinations thereof.

In an aspect, the one or more sugar oxidation products comprise a glucose oxidation product, a gluconic acid oxidation product, a gluconate, glucaric acid, an oxidized glucuronolactone, a uronic acid oxidation product, or combinations thereof. Additionally or alternatively, the one or more sugar oxidation products comprises a buffered glucose oxidation product, a buffered gluconic acid oxidation product, or combinations thereof. In some such aspects, the buffered glucose oxidation product, the buffered gluconic acid oxidation product, or combinations thereof are buffered to a pH within a range disclosed herein with any suitable acid or base such as sodium hydroxide. In an example of such aspects, the one or more sugar oxidation product comprises a mixture of gluconic acid and glucaric acid and further comprises a minor component species comprising n-keto-acids, C₂-C₆ diacids or combinations thereof.

In an aspect, the one or more sugar oxidation products comprise glucodiamine, glucodialdose, 2-ketoglucose, glucaric acid, lactones of glucaric acid, gluconic acid, lactones of gluconic acid, galactonic acid, lactones of galactonic acid, galactaric acid, lactones of galactaric acid, galactonic acid glucoheptonic acid, lactones of glucoheptonic acid, or combinations thereof.

In an aspect, the one or more one or more sugar oxidation products suitable for use in the present disclosure comprise less than about 5 wt. % maltose, maltotriose, fructose, higher molecular weight polysaccharides, oxidation products thereof, or combinations thereof based on the total weight of the sugar oxidation product.

In an aspect, the one or more sugar oxidation products comprise a mixture of gluconic acid and glucaric acid. In such aspects, the ratio of gluconic acid to glucaric acid may range from about 0.1:10 to about 10:0.1, additionally or alternatively about 0.15:10, additionally or alternatively about 0.5:10, additionally or alternatively about 1:10, additionally or alternatively about 1:5, additionally or alternatively about 1:4, additionally or alternatively about 1:3, additionally or alternatively about 1:2, additionally or alternatively about 1:1, additionally or alternatively about 10:0.1, additionally or alternatively about 10:0.5, additionally or alternatively about 10:1, additionally or alternatively about 5:1, additionally or alternatively about 4:1, additionally or alternatively about 3:1, additionally or alternatively about 2:1.

In one or more aspects, the SBC has the one or more sugar oxidation products present in an amount of about 0.1 weight percent (wt. %), or about 0.25 wt. %, additionally or alternatively about 0.5 wt. %, additionally or alternatively about 0.75 wt. %, additionally or alternatively about 1 wt. %, additionally or alternatively about 1.25 wt. %, additionally or alternatively about 1.5 wt. %, additionally or alternatively about 1.75 wt. %, additionally or alternatively about 2 wt. %, additionally or alternatively about 2.25 wt. %, additionally or alternatively about 2.5 wt. %, additionally or alternatively about 2.75 wt. %, additionally or alternatively about 3 wt. %, additionally or alternatively about 3.25 wt. %, or additionally or alternatively 3.5 wt. %, additionally or alternatively about 3.75 wt. %, additionally or alternatively about 4 wt. %, additionally or alternatively about 4.25 wt. %, additionally or alternatively about 4.5 wt. %, additionally or alternatively about 4.75 wt. %, additionally or alternatively about 5 wt. %, additionally or alternatively about 10 wt. %, additionally or alternatively about 12.5 wt. %, additionally or alternatively about 15 wt. %, additionally or alternatively about 17.5 wt. %, additionally or alternatively about 20 wt. %, additionally or alternatively about 22.5 wt. %, additionally or alternatively about 25 wt. %, additionally or alternatively about 27.5 wt. %, additionally or alternatively about 30 wt. %, additionally or alternatively about 32.5 wt. %, additionally or alternatively about 35 wt. %, additionally or alternatively about 37.5 wt. %, additionally or alternatively about 40 wt. %, additionally or alternatively about 42.5 wt. %, additionally or alternatively about 45 wt. %, additionally or alternatively about 47.5 wt. %, additionally or alternatively about 50 wt. %, additionally or alternatively about 52.5 wt. %, additionally or alternatively about 55 wt. %, additionally or alternatively about 57.5 wt. %, additionally or alternatively about 60 wt. %, additionally or alternatively about 62.5 wt. %, additionally or alternatively about 65 wt. %, additionally or alternatively about 67.5 wt. %, additionally or alternatively about 70 wt. %, additionally or alternatively about 72.5 wt. %, additionally or alternatively about 75 wt. %, additionally or alternatively about 77.5 wt. %, additionally or alternatively about 80 wt. %, additionally or alternatively about 82.5 wt. %, additionally or alternatively about 85 wt. %, additionally or alternatively about 87.5 wt. %, additionally or alternatively about 90 or from about 0.1 wt. % to about 95 wt. %, additionally or alternatively from about 5 wt. % to about 90 wt. %, additionally or alternatively from about 10 wt. % to about 90 wt. %, additionally or alternatively from about 15 wt. % to about 85 wt. %, additionally or alternatively from about 20 wt. % to about 80 wt. %, additionally or alternatively from about 25 wt. % to about 75 wt. %, additionally or alternatively from about 40 wt. % to about 60 wt. %, additionally or alternatively about 50 wt. %, additionally or alternatively about from 0.1 wt. % to about 10 wt. %, additionally or alternatively from about 1 wt. % to about 20 wt. %, additionally or alternatively from about 5 wt. % to about 50 wt. % based on the total weight of the SBC. In some aspects, the SBC has one or more sugar oxidation products present in an amount between any of the end points listed herein.

In one or more aspects, any of the one or more sugar oxidation products further comprises a cation counterpart such as a Group 1 alkali metal, a Group 2 alkaline earth metal, a Group 8 metal, Group 11 metal, Group 12 metal or a combination thereof. Nonlimiting exemplary cation counterparts include silicates, borates, aluminum, calcium, magnesium, ammonium, sodium, potassium, cesium, strontium, zinc, copper, ferric iron or ferrous iron, and combinations thereof. Alternatively, the cation counterpart is sodium, potassium, calcium or ammonium. In one or more aspects, the one or more sugar oxidation products are salt-free (or fully acidified).

In one or more aspects, the SBC is formulated to provide a biocide concentration of about 25 ppm, additionally or alternatively about 50 ppm, additionally or alternatively about 75 ppm, additionally or alternatively about 100 ppm, additionally or alternatively about 125 ppm, additionally or alternatively about 150 ppm, additionally or alternatively about 175 ppm, additionally or alternatively about 200 ppm, additionally or alternatively about 225 ppm, additionally or alternatively about 250 ppm, additionally or alternatively about 275 ppm, additionally or alternatively about 300 ppm, additionally or alternatively additionally or alternatively about 325 ppm, additionally or alternatively about 350 ppm, additionally or alternatively about 375 ppm, additionally or alternatively about 400 ppm, additionally or alternatively about 425 ppm, additionally or alternatively about 450 ppm, additionally or alternatively about 475 ppm, additionally or alternatively about 500 ppm, additionally or alternatively about 525 ppm, additionally or alternatively about 550 ppm, additionally or alternatively about 575 ppm, additionally or alternatively about 600 ppm, additionally or alternatively about 625 ppm, additionally or alternatively about 650 ppm, additionally or alternatively about 675 ppm, additionally or alternatively about 700 ppm, additionally or alternatively about 725 ppm, additionally or alternatively about 750 ppm, additionally or alternatively about 775 ppm, additionally or alternatively about 800 ppm, additionally or alternatively about 825 ppm, additionally or alternatively about 850 ppm, additionally or alternatively about 875 ppm, additionally or alternatively about 900 ppm, additionally or alternatively about 925 ppm, additionally or alternatively about 950 ppm, additionally or alternatively about 975 ppm, additionally or alternatively additionally or alternatively about 1000 ppm. Additionally or alternatively, the SBC is formulated to provide a biocide potentiator concentration of about 25 ppm, additionally or alternatively additionally or alternatively about 50 ppm, additionally or alternatively about 75 ppm, additionally or alternatively about 100 ppm, additionally or alternatively about 125 ppm, additionally or alternatively about 150 ppm, additionally or alternatively about 175 ppm, additionally or alternatively about 200 ppm, additionally or alternatively about 225 ppm, additionally or alternatively about 250 ppm, additionally or alternatively about 275 ppm, additionally or alternatively about 300 ppm, additionally or alternatively about 325 ppm, additionally or alternatively about 350 ppm, additionally or alternatively about 375 ppm, additionally or alternatively about 400 ppm, additionally or alternatively about 425 ppm, additionally or alternatively about 450 ppm, additionally or alternatively about 475 ppm, additionally or alternatively about 500 ppm, additionally or alternatively about 525 ppm, additionally or alternatively about 550 ppm, additionally or alternatively about 575 ppm, additionally or alternatively about 600 ppm, additionally or alternatively about 625 ppm, additionally or alternatively about 650 ppm, additionally or alternatively about 675 ppm, additionally or alternatively about 700 ppm, additionally or alternatively about 725 ppm, additionally or alternatively additionally or alternatively about 750 ppm, additionally or alternatively about 775 ppm, additionally or alternatively about 800 ppm, additionally or alternatively about 825 ppm, additionally or alternatively about 850 ppm, additionally or alternatively about 875 ppm, additionally or alternatively about 900 ppm, additionally or alternatively about 925 ppm, additionally or alternatively about 950 ppm, about 975 ppm, additionally or alternatively about 1000 ppm.

In one or more aspects, the SBC contains a ratio of biocide to biocide potentiator ranging from about 100:1 to about 1:100; additionally or alternatively from about 90:10 to about 10:90; additionally or alternatively from about 80:20 to about 20:80; additionally or alternatively from about 70:30 to about 30:70 additionally or alternatively from about 60:40 to about 40:60; additionally or alternatively about 50:50.

In one or more aspects, a method of the present disclosure comprises the introduction of an SBC to one or more systems comprising aqueous fluids. The SBC may be introduced using any suitable methodology for the introduction of materials to the one or more systems comprising aqueous fluids. For example, the one or more systems comprising aqueous fluids may be a wellbore disposed within a subterranean formation. The SBC may be introduced by being placed downhole in the presence or absence of other treatment fluids introduced to the wellbore. In one or more aspects, a SBC may be introduced to an oilfield system to reduce or prevent Microbially Influenced Corrosion and/or to significantly prevent/delay the onset of souring and biofilm plugging of fractures in the oilfield (e.g., shale formation).

In one or more aspects, an SBC of the present disclosure when introduced to a system comprising aqueous fluids provides biocidal activity that is equal to or greater than the biocidal activity observed when using the identical biocide in the absence of one or more sugar oxidation products of the type disclosed herein. Hereinafter the biocidal activity of the biocide in the absence of one or more sugar oxidation products is termed the base biocidal activity or “BBA.” In an aspect, the SBC has a biocidal activity that is from about 10% to about 100% greater than the BBA, additionally or alternatively from about 20% to about 80% greater than the BBA; additionally or alternatively from about 30% to about 80% greater than the BBA.

In an aspect, if the amount of biocide, designated a, is needed to produce a level of biocidal activity designated y, then the SBC provides a level of biocidal activity y using from about 0.1 a to about 0.9 a, additionally or alternatively from about 0.25 a to about 0.9 a, additionally or alternatively about 0.5 a, additionally or alternatively about 0.25 a. The SBC allows for the use of less biocide to achieve the level of biocidal activity produced by a larger amount of biocide alone. In other words, the oxidized sugar product potentiates the biocidal activity rendering the biocide effective at a lower concentration.

In an aspect, an SBC may be included in an aqueous wellbore servicing fluid such as a cement or a drilling fluid and placed into a wellbore. In other aspects, an SBC may be introduced as a solid to a system comprising an aqueous fluid.

### Additional Disclosure

The following are additional nonlimiting aspects of the presently disclosed subject matter

A first aspect which is a composition comprising (i) a biocide and (ii) a biocide potentiator comprising a sugar oxidation product.

A second aspect which is the composition of the first aspect wherein the biocide potentiator reacts to produce at least one product having a biocidal activity greater than the biocide potentiator.

A third aspect which is the composition of any of the first through second aspects wherein the biocide comprises 1,3-bis(hydroxymethyl)-5,5-dimethylimidazolidine-2,4-dione (DMDM hydantoin), 3,5-dimethyl-1,3,5-thiadiazinane-2-thione (DAZOMET), tris(hydroxymethyl)nitromethane (THNM), cetyltrimethylammonium chloride (CTAC), 3,3′-methylenebis[5-methyloxazolidine (MBO), 2,6-dimethyl-m-dioxane-4-ol acetate (DMO), (ethylenedioxy)dimethanol (EDDM), tetramethylolacetylene diurea (TMAD), benzylhemiformal, 2-bromo-2-nitropropane-1,3-diol, 5-bromo-5-nitro-1,3-dioxane, diazolidinyl urea, imidazolidinyl urea, sodium hydroxymethylglycinate, hexamethylenetetramine chloroallyl chloride (QUATERNIUM-15) or combinations thereof.

A fourth aspect which is the composition of any of the first through third aspects wherein the biocide potentiator comprises aldonic acid, uronic acid, aldaric acid or a combination thereof.

A fifth aspect which is the composition of any of the first through fourth aspects wherein the sugar oxidation product comprises galactonic acid, galactaric acid, an oxidation product comprising predominantly galactonic acid, galactaric acid or combinations thereof with minor component species of n-keto-acids, C₂ to C₆ diacids, or combination thereof.

A sixth aspect which is the composition of any of the first through fifth aspects, wherein the sugar oxidation product comprises of a mixture of gluconic acid and glucaric acid.

A seventh aspect which is the composition of the sixth aspect wherein the ratio of gluconic acid to glucaric acid ranges from about 0.1:10 to about 10:0.1.

An eighth aspect which is the composition of any of the first through seventh aspects wherein the biocide is present in an amount of from about 25 ppm to about 1000 ppm.

A ninth aspect which is the composition of any of the first through eighth aspects wherein a ratio of biocide: biocide potentiator ranging from about 100:1 to about 1:100.

A tenth aspect which is the composition of any of the first through ninth aspect wherein the composition provides a level of biocidal activity that ranges from about 10% greater to about 100% greater than the level of biocidal activity observed in the presence of the biocide alone.

An eleventh aspect which is a method of servicing a system comprising an aqueous fluid comprising introducing to the system an aqueous composition comprising (i) a biocide and (ii) a biocide potentiator comprising a sugar oxidation product.

A twelfth aspect which is the method of the eleventh aspect wherein the biocide potentiator reacts to produce at least one product having a biocidal activity greater than the biocide potentiator.

A thirteenth aspect which is the method of any of the eleventh through twelfth aspects wherein the biocide comprises 1,3-bis(hydroxymethyl)-5,5-dimethylimidazolidine-2,4-dione (DMDM hydantoin), 3,5-dimethyl-1,3,5-thiadiazinane-2-thione (DAZOMET), tris(hydroxymethyl)nitromethane (THNM), cetyltrimethylammonium chloride (CTAC), 3,3′-methylenebis[5-methyloxazolidine (MBO), 2,6-dimethyl-m-dioxane-4-ol acetate (DMO), (ethylenedioxy)dimethanol (EDDM), tetramethylolacetylene diurea (TMAD), benzylhemiformal, 2-bromo-2-nitropropane-1,3-diol, 5-bromo-5-nitro-1,3-dioxane, diazolidinyl urea, imidazolidinyl urea, sodium hydroxymethylglycinate, hexamethylenetetramine chloroallyl chloride (QUATERNIUM-15) or combinations thereof.

A fourteenth aspect which is the method of any of the eleventh through thirteenth aspects wherein the biocide potentiator comprises aldonic acid, uronic acid, aldaric acid or a combination thereof.

A fifteenth aspect which is the method of any of the eleventh through fourteenth aspects wherein the sugar oxidation product comprises galactonic acid, galactaric acid, an oxidation product comprising predominantly (e.g., greater than about 50 weight percent) galactonic acid and/or galactaric acid with minor component species of n-keto-acids, C2 to C6 diacids, or combination thereof.

A sixteenth aspect which is the method of any of the eleventh through fifteenth aspects wherein the sugar oxidation product comprises of a mixture of gluconic acid and glucaric acid.

A seventeenth aspect which is the method of the sixteenth aspect wherein the ratio of gluconic acid to glucaric acid ranges from about 0.1:10 to about 10:0.1.

An eighteenth aspect which is the method of any of the eleventh through seventeenth aspects wherein the biocide is present in an amount of from about 25 ppm to about 1000 ppm.

A nineteenth aspect which is the method of any of the eleventh through eighteenth aspects wherein a ratio of biocide: biocide potentiator ranging from about 100:1 to about 1:100.

A twentieth aspect which is the method of any of the eleventh through nineteenth aspects, wherein the composition provides a level of biocidal activity that ranges from about 10% greater to about 100% greater than the level of biocidal activity observed in the presence of the biocide alone.

A twenty-first aspect which is the method of any of the eleventh through twentieth aspects wherein the system comprising an aqueous fluid is a wellbore disposed within a subterranean formation.

### EXAMPLES

The aspects having been generally described, the following examples are given as particular aspects of the disclosure and to demonstrate the practice and advantages thereof. It is understood that the examples are given by way of illustration and are not intended to limit the specification of the claims in any manner. The following examples described are prophetic.

### Example 1

The effectiveness of an SBC of the type disclosed herein as an antimicrobial will be investigated. Upon receipt of water samples an initial microbial plate count will be conducted in the following manner:

Microbiological Plate Count Method:

Under aseptic conditions, one (1) milliliter (ml) of the sample is added to 99 ml of phosphate dilution buffer. One (1) milliliter (ml) of the diluted material and one-tenth of the diluted material is then transferred to sterile Petri dishes. This gives 1:100 and 1:1000 dilutions of the material, respectively. A growth medium of Trypticase Soy Agar (TSA) will be utilized for the facilitation of general aerobic bacteria, Fluid Thioglycolate Medium (FTM) wo; be used for the facilitation of anaerobic sulfate reducing bacteria and Phenol Red Dextrose (PRD) for the facilitation of anaerobic acid producing bacteria. The dishes will be incubated at 37 °C for 24-48 hours, with TSA plates incubated under aerobic conditions and both the FTM and PRD plates added to an anerobic gas pack for incubation. Bacterial colonies will then be recorded and reported as colony forming units per ml of samples (cfu/ml). The colony count falling between 30 and 300 will be selected and multiplied by the reciprocal of the dilution factor to obtain the bacterial count per ml of samples.

The 30 to 300 range is used because under 30 the chance of sampling error may be significant and over 300, due to overcrowding on the plate, there may be formed a single colony by more than one microorganism.

After the microbial condition of each water sample is analyzed, those wild strain microorganisms will be isolated and used with the recommended ATCC organisms to make up a mixed bacterial inoculum for the study.

The ATCC organisms to be used are identified as follows:

### General Bacteria:

Escherichia coli, ATCC 8739, Enterobacter aerogenes, ATCC 13048

### Sulfate Reducing Bacteria:

Desulfovibrio desulfuricans, ATCC 29577 and Desulfovibrio vulgaris, ATCC 29577

### Acid Producing Bacteria:

Clostridium acetobutylicum, ATCC 4295

Total prepared inoculum strength will be 1.0×10⁵ cfu/ml.

### Efficacy

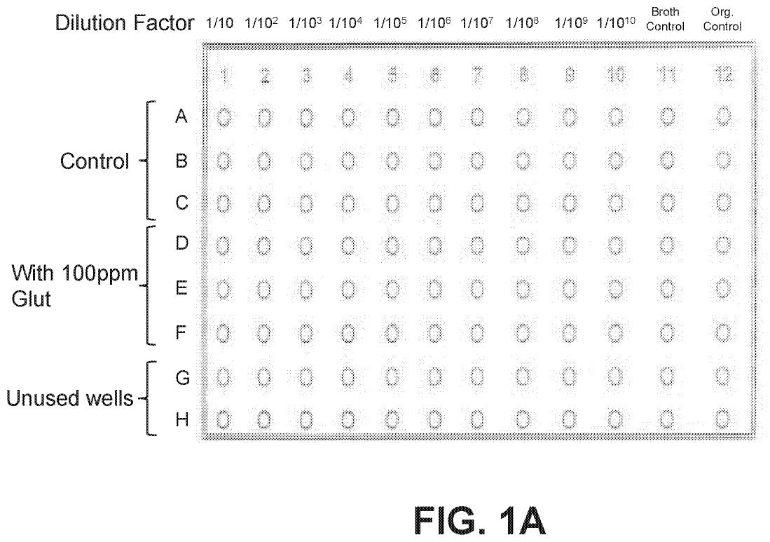

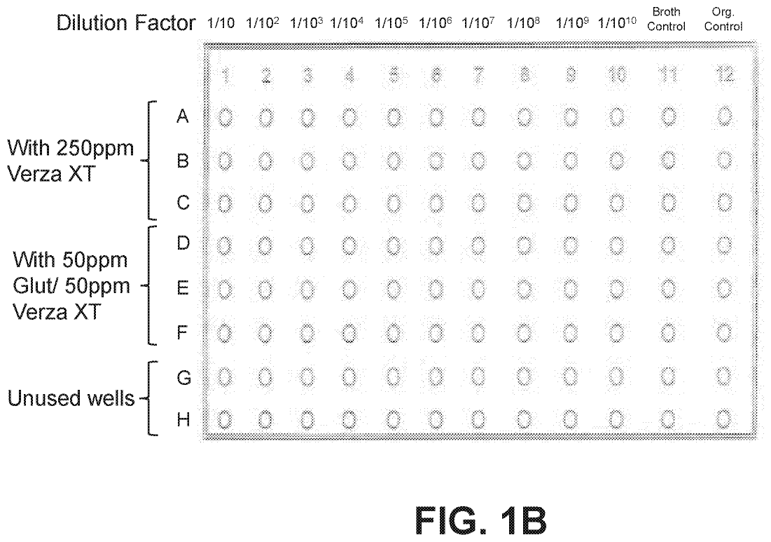

20 ml aliquots will be weighed out for each submitted water sample and treated with different biocide and. VERZA 360 XT dosages, the biocide potentiator, and 4 hours contact time. VERZA360 XT is an organic acid-based iron control agent derived from plant-based materials commercially available from SOLUGEN. Once treated, all samples will be inoculated with 1ml of the prepared inoculum, mixed thoroughly and allowed to incubate at 35 °C for 4 hours. After 4 hours, 96 well microtiter plates will be prepared for serial dilutions of each sample. Sample microtiter plate configurations are presented in FIGS. 1A and 1B. All test aliquots will be tested in triplicate and column one to column twelve for each plate will hold 90 μl of the appropriate broth and then serially diluted (10 μl of the test aliquot added to column #1 mixed and then 1 ul from this column taken and added to column #2, and so forth all the way to column to #10. Column #11, will act as the broth control, while Column #12 will act as the inoculum control. For the evaluation of general bacteria and acid producing bacteria, the broth medium will be Phenol Red Dextrose Broth, and for sulfate reducing bacteria, the broth medium will be Anaerobic Modified Postgate Broth.

The same procedure will again be performed for each water sample at 24 hours. All plates will be incubated at 35 °C for 7 to 14 days and viable microbial counts (log10) estimated using the modified most probable number (MPN) enumeration method. Visual observations will be recorded for all wells, with positive results for general bacteria noted as any turbidity in the well, a red color changing to yellow color in the well for acid producing bacteria and a beige color changing to grey/black color in the well for sulfate reducing bacteria.

### For Long-Term Preservatives

Long term biocides (e.g., DAZOMET, THNM, MBO and CTAT) will be tested as components of the SNC. Biocide efficacy testing would be conducted via a “modified bug bottle” test. 20 ml (twenty) aliquots of an identified water sample would be weighed out and treated with various levels of biocides to be investigated. Following the addition of the biocide(s) each aliquot would be incubated (heat aging) at 60 °C for specified time periods (1, 7, 14, 21 and 28 days). At each specified time, the samples will be taken out of the incubator and inoculated with 1.0 E+06 cfu/ml of wild stain APB's and SRB's. After 24-hour incubation at 35 °C, samples will be evaluated for biocide efficacy following the modified bug bottle test as described before.

General Bacteria and Acid Producing Plate, all utilized wells will contain 90 μl of the phenol red dextrose broth for serial dilutions. For the Sulfate Reducing Bacteria, all utilized wells will contain 90 μl of the postgate broth for serial dilutions.

While various aspects have been shown and described, modifications thereof can be made by one skilled in the art without departing from the spirit and teachings of the disclosure. The aspects described herein are exemplary only and are not intended to be limiting. Many variations and modifications of the aspects disclosed herein are possible and are within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes 2, 3, 4 etc. ; greater than 0.10 includes 0.11, 0.12, 0.13, etc.). Use of the term “optionally” with respect to any element of a claim is intended to mean that the subject element is required, or alternatively is not required. Both alternatives are intended to be within the scope of the claim. Use of broader terms such as comprises includes having etc. should be understood to provide support for narrower terms such as consisting of consisting essentially of comprised substantially of etc.

Accordingly the scope of protection is not limited by the description set out above but is only limited by the claims which follow, that scope including all equivalents of the subject matter of the claims. Each and every claim is incorporated into the specification as an aspect of the present disclosure. Thus, the claims are a further description and are an addition to the aspects disclosed herein. The discussion of a reference herein is not an admission that it is prior art to the present disclosure, especially any reference that may have a publication date after the priority date of this application. The disclosures of all patents, patent applications, and publications cited herein are hereby incorporated by reference, to the extent that they provide exemplary %, procedural or other details supplementary to those set forth herein.

What is claimed is:

1. A composition, comprising:
(i) a biocide, and
(ii) a biocide potentiator comprising a sugar oxidation product.

2. The composition of claim 1, wherein the biocide potentiator reacts to produce at least one product having a biocidal activity greater than the biocide potentiator.

3. The composition of claim 1, wherein the biocide comprises 1,3-bis(hydroxymethyl)-5,5-dimethylimidazolidine-2,4-dione (DMDM hydantoin), 3,5-dimethyl-1,3,5-thiadiazinane-2-thione (DAZOMET), tris(hydroxymethyl)nitromethane (THNM), cetyltrimethylammonium chloride (CTAC), 3,3′-methylenebis[5-methyloxazolidine (MBO), 2,6-dimethyl-m-dioxane-4-ol acetate (DMO), (ethylenedioxy)dimethanol (EDDM), tetramethylolacetylene diurea (TMAD), benzylhemiformal, 2-bromo-2-nitropropane-1,3-diol, 5-bromo-5-nitro-1,3-dioxane, diazolidinyl urea, imidazolidinyl urea, sodium hydroxymethylglycinate, hexamethylenetetramine chloroallyl chloride (QUATERNIUM-15) or combinations thereof.

4. The composition of claim 1, wherein the biocide potentiator comprises aldonic acid, uronic acid, aldaric acid or a combination thereof.

5. The composition of claim 1, wherein the sugar oxidation product comprises galactonic acid, galactaric acid, an oxidation product comprising galactonic acid, galactaric acid or combinations thereof with minor component species of n-keto-acids, C₂ to C₆ diacids, or combination thereof.

6. The composition of claim 1, wherein the sugar oxidation product comprises of a mixture of gluconic acid and glucaric acid.

7. The composition of claim 1, wherein the ratio of gluconic acid to glucaric acid ranges from about 0.1:10 to about 10:0.1.

8. The composition of claim 1, wherein the biocide is present in an amount of from about 25 ppm to about 1000 ppm.

9. The composition of claim 1, wherein a ratio of biocide: biocide potentiator ranging from about 100:1 to about 1:100.

10. The composition of claim 1, wherein the composition provides a level of biocidal activity that ranges from about 10% greater to about 100% greater than the level of biocidal activity observed in the presence of the biocide alone.

11. A method of servicing a system comprising an aqueous fluid, the method comprising:
introducing to the system an aqueous composition comprising (i) a biocide and (ii) a biocide potentiator comprising a sugar oxidation product.

12. The method of claim 11, wherein the biocide potentiator reacts to produce at least one product having a biocidal activity greater than the biocide potentiator.

13. The method of claim 11, wherein the biocide comprises 1,3-bis(hydroxymethyl)-5,5-dimethylimidazolidine-2,4-dione (DMDM hydantoin), 3,5-dimethyl-1,3,5-thiadiazinane-2-thione (DAZOMET), tris(hydroxymethyl)nitromethane (THNM), cetyltrimethylammonium chloride (CTAC), 3,3′-methylenebis[5-methyloxazolidine (MBO), 2,6-dimethyl-m-dioxane-4-ol acetate (DMO), (ethylenedioxy)dimethanol (EDDM), tetramethylolacetylene diurea (TMAD), benzylhemiformal, 2-bromo-2-nitropropane-1,3-diol, 5-bromo-5-nitro-1,3-dioxane, diazolidinyl urea, imidazolidinyl urea, sodium hydroxymethylglycinate, hexamethylenetetramine chloroallyl chloride (QUATERNIUM-15) or combinations thereof.

14. The method of claim 11, wherein the biocide potentiator comprises aldonic acid, uronic acid, aldaric acid or a combination thereof.

15. The method of claim 11, wherein the sugar oxidation product comprises galactonic acid, galactaric acid, an oxidation product comprising predominantly galactonic acid, galactaric acid or combinations thereof with minor component species of n-keto-acids, C₂ to C₆ diacids, or combination thereof.

16. The method of claim 11, wherein the sugar oxidation product comprises of a mixture of gluconic acid and glucaric acid.

17. The method of claim 11, wherein the ratio of gluconic acid to glucaric acid ranges from about 0.1:10 to about 10:0.1.

18. The method of claim 11, wherein the biocide is present in an amount of from about 25 ppm to about 1000 ppm.

19. The method of claim 11, wherein a ratio of biocide: biocide potentiator ranging from about 100:1 to about 1:100.

20. The method of claim 11, wherein the composition provides a level of biocidal activity that ranges from about 10% greater to about 100% greater than the level of biocidal activity observed in the presence of the biocide alone.

21. The method of claim 11, wherein the system comprising an aqueous fluid is a wellbore disposed within a subterranean formation.
